(19) United States
(12) Patent Application Publication
(10) Pub. No.: US 2006/0253880 A1
(43) Pub. Date: Nov. 9, 2006

(54) System for adapting television entertainment network setup in remote locations

(75) Inventors: Dharmesh N. Bhakta, Austin, TX (US); Juan F. Obas, Austin, TX (US); Trung Q. Ly, Austin, TX (US); Lakshmi N. Potluri, Austin, TX (US)

Correspondence Address: MCGRATH, GEISSLER, OLDS & RICHARDSON, PLLC, P.O. BOX 7085, ALEXANDRIA, VA, 22307, US

(73) Assignee: International Business Machines Corporation

(21) Appl. No.: 11/121,128

(22) Filed: May 3, 2005

(51) Int. Cl. H04N 7/18

(52) U.S. Cl. 725/81; 725/80

(57) ABSTRACT

Methods and apparatus are provided for adapting television channel numbers at a home location to the corresponding television channels, if any, at a visited location. Television channel mapping information is stored in a portable channel mapping storage unit. The portable channel mapping storage unit may be connected to a television set in a visited location, and the visited television set maps its received channels to corresponding channels of the home set. The visited television can then display home channel numbers for its received channels which are the same, or correspond, to channels received at the home television set.

### FIELD OF THE INVENTION

The present invention relates generally to menus for electronic content. More specifically the present invention relates to apparatus and methods for adapting a television menu interface system.

### BACKGROUND OF THE INVENTION

The number of television channels has increased considerably with the availability of satellite and cable television. Since satellite, cable and broadcast network providers each have different channel mappings, there are literally hundreds, possibly even thousands, of different channels available across the nation. An individual who travels is constantly faced with the prospect of trying to read television guides to figure out which providers are available on the channels in different regions. Individuals often get frustrated and end up not getting to watch the programs of their choice. Frequent travelers may face a confusion of a different sort in that they may become attuned to the channel setup in a different region to such an extent that at home they are not familiar with the available channel selection.

A system has been proposed to aid in solving this problem, for example, the document entitled “Method and System for Mobile Viewing Preference Transport” (Posted at http://www.priorartdatabase.com/IPCOM/000019047/; document reference IPCOM # 000019047D dated Apr. 22, 2003). In this proposed system a user would access an Internet database of channels for various regions using a standard web browser. The web-based interface would be presented to the user upon entering the origin and destination cities, as well as the specifics of the service providers. However, there are some drawbacks for such a system. First, access to the Internet is required in order to use the system. Further, the channel mapping has to be done manually. Finally, the system requires that two or more databases of channel mappings must be implemented.

What is needed is a convenient and reliable way of allowing users to tune to the channel numbers they are accustomed to, even in remote locations.

### SUMMARY OF THE INVENTION

Various exemplary embodiments provide methods and apparatus for adapting an entertainment network setup in a visited location to the setup of a home location. At least one embodiment includes storing information in a portable channel mapping storage unit, the information defining the channels received at a home television. The portable channel mapping storage unit may be connected to a television set in a visited location, and the visited television set maps its received channels to corresponding channels of the home set. The visited television can then display home channel numbers for channels which are the same (or correspond) at the visited location as compared to channels received at the home television set.

### BRIEF DESCRIPTION OF THE DRAWINGS

Embodiments of present invention will become more fully understood from the detailed description and the accompanying drawings, wherein:

FIGS. 1A, 1B and 1C depict aspects of an entertainment network system for implementing various embodiments of the invention;

FIG. 2 illustrates methods for channel mapping for home channels and the channels of a visited region; and

FIG. 3 is a flowchart of activities for a method for adapting an entertainment network setup in a remote location, in accordance with at least one exemplary embodiment.

### DETAILED DESCRIPTION

The following description of the various exemplary embodiments is illustrative in nature and is not intended to limit the invention, its application, or uses.

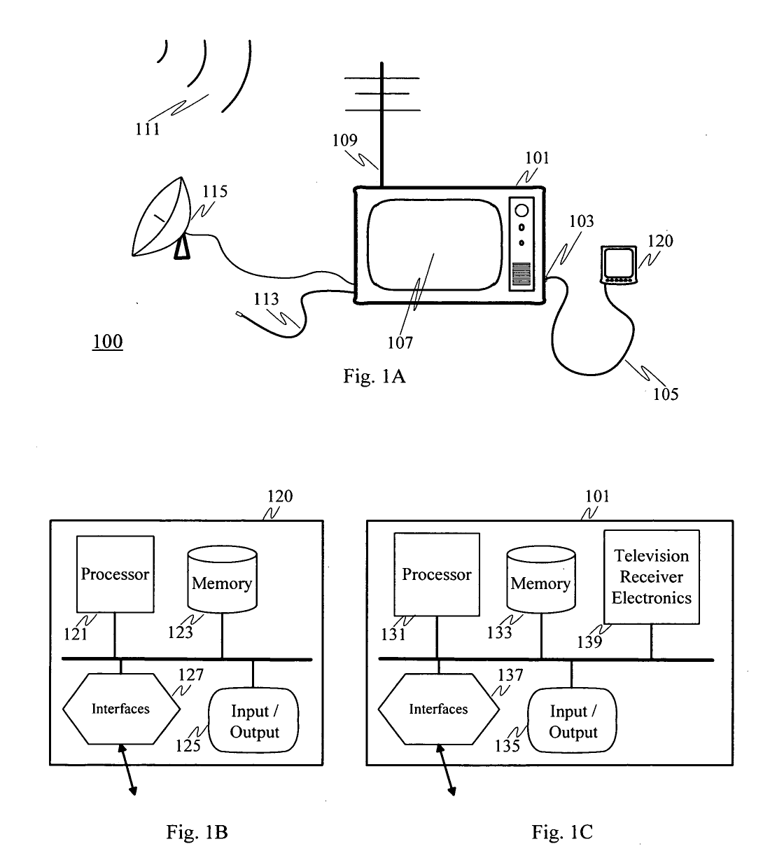

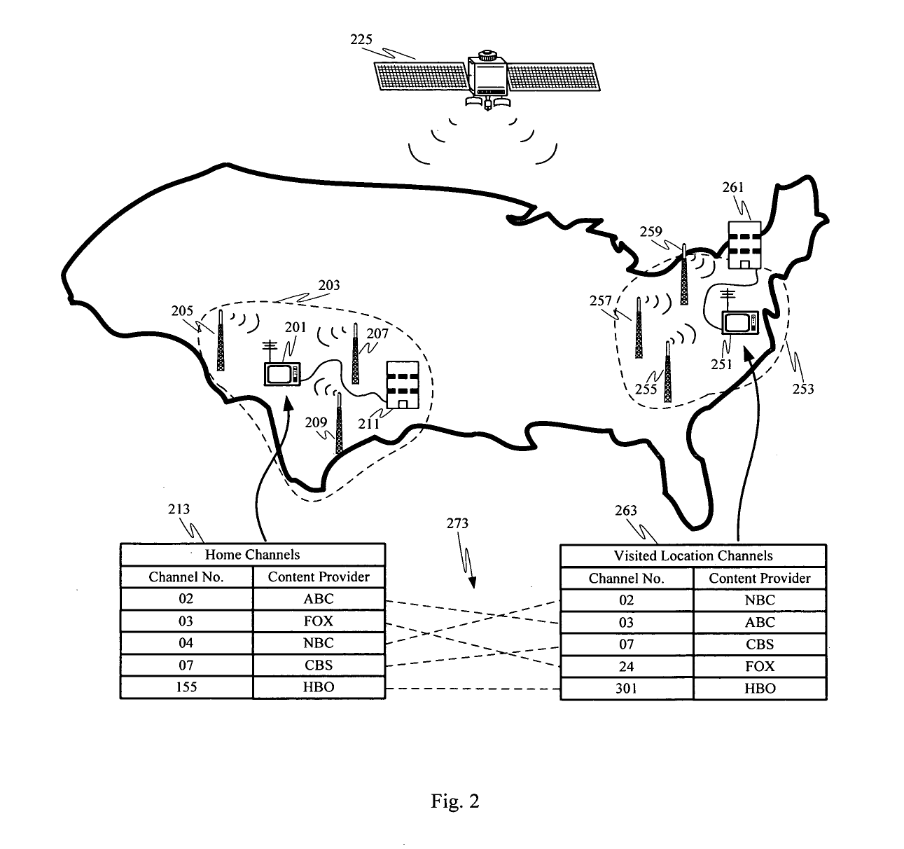

FIGS. 1A, 1B and 1C depict aspects of an entertainment network system 100 for implementing various embodiments of the invention. The system 100 includes one or more television sets 101 and a channel mapping storage unit 120 as shown in FIG. 1A. The television set 101 includes at least one input for receiving television signals encoded with content. For example, the television set 101 may include a cable interface 113 for receiving cable television signals, and/or an antenna 109 for receiving broadcast signals. The antenna 109 may be configured to receive broadcast signals 111 from land-based broadcast antennas (e.g., 205, 207 and 209 of FIG. 2) or may be configured to receive television signals transmitted from a satellite. Typically, dish antennas such as dish 115 are used on television set 101 to receive satellite transmissions.

The channel mapping storage unit 120 may be implemented in the form of a memory stick or other storage device, or may be a portable electronic device such as a personal digital assistant (PDA), a laptop computer, a television remote control, or possibly even a cellular telephone or any other like type of portable electronic device capable of storing information and providing signals or controls. The channel mapping storage unit 120 may be connected to the television set 101 wirelessly (e.g., infrared signals, or other wireless signals), or may be connected via a cable connection 105. The connector cable 105 connects to an input interface 103 of television 101. The input interface 103 may be configured to be compatible with an Enhanced Memory Stick slot, or other like type of port or interface suitable for receiving signals from the channel mapping storage unit 120 such as a Multi Flash Card Reader/Writer which reads and writes to all memory cards, including Smart Media, Compact Flash, Multi Media, Secure Digital, Sony Memory Stick, IBM MicroDrive, xD Card and Sony Memory Stick Pro. Most new TV models already come equipped with Enhanced Memory Stick slots. Enhanced Memory Stick slots allow the television to read any memory stick plugged into the reader slot. The content of the memory stick may be images, text or other type of data. In various embodiments of the invention the input interface 103 is compatible with Enhanced Memory Stick slot technology, but altered to perform write commands on the memory stick, which would in turn allow a user to store the channellisting.lst file on the plugged in memory stick.

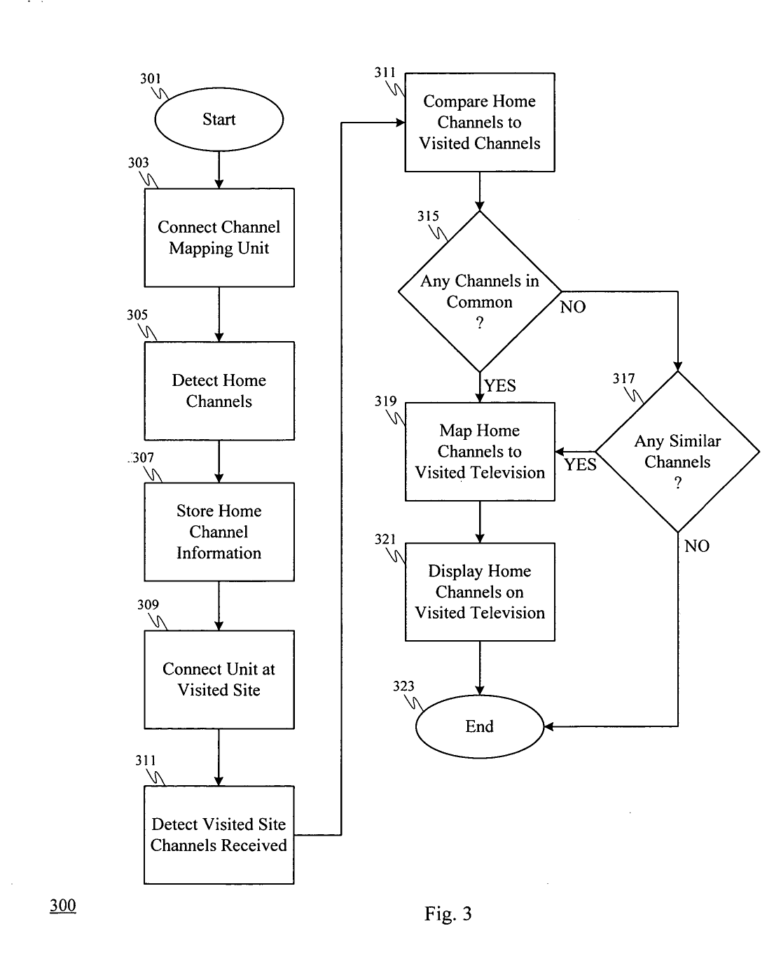

As shown in FIG. 1B the channel mapping storage unit 120 typically includes a processor 121 containing circuitry or other logic capable of performing or controlling the processes and activities involved in the embodiments disclosed herein. The processor 121 is generally embodied as a microprocessor or an application specific integrated circuit (ASIC), but may be a combination of two or more distributed processors or any other circuitry capable of carrying out commands or instructions such as those of a computer program. For example, in some embodiments the processor 121 may run a computer program or routine which performs one or more of the activities depicted in FIG. 3. In some embodiments the logic or circuitry for performing some of the activities of FIG. 3 may be provided by the channel mapping storage unit 120 while other activities are performed by the television set 101. In other embodiments the channel mapping storage unit 120 may serve as a memory for storing channel mapping information, in which case the logic for performing the activities of FIG. 3 may be wholly provided by the television set 101.

The processor 121 is configured to communicate with a memory 123, for example, via a buss or other communication link. The memory 123 may be any of several types of storage devices used for storing computer programs, routines, or data, including instructions and data for carrying out activities of the various embodiments such as the activities discussed in conjunction with FIG. 3. The memory 123 may be embodied in any of several different forms, for example, as random access memory (RAM), read only memory (ROM), flash memory, registers, hard disk, or removable media such as a magnetic or optical disk, or other storage medium known in the art. The memory 123 may comprise a combination of one or more of any of these storage devices.

The channel mapping storage unit 120 also includes one or more input/output (I/O) units 125 such as a port for attaching the connector cable 105. The channel mapping storage unit 120 may include as an I/O unit 125 one or more of a monitor or screen such as an LCD screen, a keyboard and/or tablet surface and pen, and possibly a mouse or other like types of input/output devices. If the channel mapping storage unit 120 connects to television set 101 wirelessly, the channel mapping storage unit 120 would be configured to include an interface unit 127 such as an infrared transmitter or other wireless transmitter and/or receiver. In some embodiments the channel mapping storage unit 120 serves as a memory for storing channel mapping information, and the activities of FIG. 3 are controlled and performed by the television set 101.

The television set 101 may include a processor 131, a memory 133, and I/O unit 135, and an interface unit 137 as shown in FIG. IC. These elements include functions and structures known to those of ordinary skill in the art, and may include functions and structures similar to the corresponding elements of the channel mapping storage unit 120 described above. The interfaces 137 may include an Enhanced Memory Stick slot of the television set 101 and the I/O unit 135 may be a television screen 107 of the television set 101. Typically, the television screen 107 displays the channel number. However, the television 101 may include another display (e.g., an LED display) dedicated to displaying the channel numbers. The interfaces 137 also include an infrared receiver configured to receive signals from a television remote control for tuning the channels of television 101, adjusting the volume or other settings. The television set 101 also includes television receiver electronics 139 suitable for receiving, decoding and displaying a television signal.

FIG. 2 illustrates home channels being mapped over to channels in a visited location. A user has a television set designated as their home television set 201 since it has channel labels with which the user is familiar, e.g., the channels received at the user's home or place of work. The home television set 201 receives signals from television content providers for the home television region 203. The television content providers may include one or more broadcast stations 205-9 transmitting from ground-based antennas. The home television set 201 may also receive cable television signals from a cable provider 211 operating a cable system in the home television region 203. The home television set 201 may also receive satellite television signals from a satellite 225 configured to broadcast television signals. One or more of these television signals may be provided to the home television set 201. Similarly, a visited television set 251 in a visited television region 253 typically receives television signals from one or more sources such as broadcast stations 255-9, cable provider 261, and satellite 225. It is sometimes the case that the same geostationary satellite transmits a signal both to a home region 203 and to a visited television region 253 which may be hundreds or even thousands of miles away. The signal received at both locations may be the same signal containing the same content and may be labeled with the same channel number, or may be labeled with a different channel number in each location even though the content transmitted to each location is the same.

In some home television sets 201, once the user turns on the set for the first time in the home television region 203 the channels for the received stations are detected and are set to the numbers on the TV remote control. Based on the channel number settings, a channel mapping.lst file may be generated containing the information of home channel mapping data 213. At this juncture the user may be presented with an option to save the mapping.lst file immediately or at a later time. The channel number settings are saved in channel mapping storage unit 120 as home channel mapping data 213. After the home channel mapping data 213 are saved in channel mapping storage unit 120, the user may carry the portable device to his/her destination for use in a visited location such as visited television region 253. For instance, when the traveling user checks into a hotel he/she may insert the channel mapping storage unit 120 into a slot provided on the visited television set 251. The input slot may be an input interface 103 compatible with a standard protocol such as the Enhanced Memory Stick slot. The local listing of the channels for the visited television region 253 may look like the visited channel mapping data 263.

The visited television set 251 may be configured with a controller device (e.g., processor 131 of FIG. 1C) or sensor capable of sensing connection of the portable channel mapping storage unit 120 into the input interface 103. Upon being connected to the television, the controller of visited television set 251 reads the channelmapping.lst file and maps the visited channel mapping data 263 to the home channel mapping data 213. Logically, the mapping done by the controller may look like channel mapping 273 between the home channel mapping data 213 and the visited channel mapping data 263. The channel mapping 273 may be stored in the visited television set 251. In other embodiments a processor 121 of the channel mapping storage unit 120 may control the mapping of the visited channel mapping data 263 to the home channel mapping data 213. In such embodiments the channel mapping 273 is stored in the channel mapping storage unit 120 instead of the visited television set 251.

Once the channel mapping 273 has been stored the user may watch television and select the channels that he or she is used to at home. For example, assume that the user wishes to watch the FOX channel. The controller then goes through the local listing as shown in FIG. 2 and identifies that the FOX station is channel 24. After determining this, the visited television set 251 now displays FOX channel 24 to the viewer (even though the local FOX affiliate may be identified with another channel number in the visited location).

FIG. 3 is a flowchart 300 of activities for a method for adapting an entertainment network setup in a remote location, in accordance with at least one exemplary embodiment. The method begins at 301 and proceeds to 303 where the channel mapping storage unit is connected to a home television set. The home television set preferably includes an input interface configured to be compatible with an Enhanced Memory Stick slot or other like type of port or interface suitable for reading from and writing to the channel mapping storage unit. Upon connecting the channel mapping storage unit to the home television set the method proceeds to 305 to detect the home channels, that is, the channels received within the home television region by the home television set. The home channels may also include channels designated for inputs which are specific to the user's own home, such as the user's VCR, stereo system, or other audio-video input device. The home channels may be detected when the user turns on the set for the first time in the home television region, or the home channels may have been detected previously and stored within the home television set. In either case a file (e.g., channel mapping.lst file) containing home channel mapping data is generated based on the received channels which have been detected or previously stored and the method proceeds from 305 to 307.

In 307 the channel mapping.lst file containing home channel mapping data is stored in the channel mapping storage unit. The channel mapping data, which defines the received channels, may include information such as the home channel mapping data 213 depicted in FIG. 2. The home channel mapping data may include identifying data of the national television network (e.g., national television networks such as NBC, CBS, FOX or ABC) which provides content for the local station. Further, in order to ease the burden of matching various local stations which may be affiliated with a national television network, the data may include a list of local affiliates for each of the national broadcast networks. Once the data has been stored the user is ready to take the channel mapping storage unit to a remote site. In accordance with block 309 of the method the user connects the channel mapping storage unit to a television set in a visited region (e.g., the set 251 in visited region 253 depicted in FIG. 2).

The television set at the visited site may be configured to sense the connection of the channel mapping storage unit containing channel mapping information. For example, the interface unit or Enhanced Memory Stick slot of the television set may detect a change in voltage, current, resistance or some other parameter at the port, or the sensing may be achieved through mechanical means (e.g., tripping a switch). The method proceeds to 311 and, upon having the channel mapping storage unit connected to it, the visited television detects the channel mapping data stored in the channel mapping storage unit. In 313 the visited television set compares the home channel mapping data from the channel mapping storage unit (e.g., channel mapping.lst file) to the visited channel mapping data, and the method proceeds to 315.

In 315 it is determined whether any of the channels listed in the home channel mapping data are affiliated with channels from the visited channel mapping data. By affiliated it is meant that a channel provider in the home region (e.g., the local television station) receives content from the same source (e.g., national television networks such as NBC, CBS, FOX or ABC) as a channel provider in the visited region. In such instances a channel in the visited region which is affiliated with a channel in the home region often carries the same national programming (e.g., NBC Nightly News), but the local programs (e.g., local nightly news) differ from the home region as compared to the visited remote region.

If, in 315, it is determined that there are no channels in common, the method proceeds along the “NO” branch to 317 where it is determined whether there are any similar channels. By “similar” it is meant that the content source is different, but the content is of the same type. For example, the CNN news channel is similar to the FOX News channel since they both primarily carry news reports and current events. For the purposes of determining whether a channel is similar or not, a channel may be categorized by the type of programming it primarily tends to carry, for example, sports, news, movies, TV sitcoms, weather reports, political commentary, remote shopping, cartoons, children's programming, adult themes, or the like. Two channels carrying primarily the same type of programming may be considered similar. If, in 317, it is determined that there are no similar channels the method proceeds along the “NO” branch to 323 where the method ends.

If, in 317, it is determined that there are channels in the visited region which are similar to channels in the home region, the method proceeds along the “YES” branch to 319. Also, back in 315, if it is determined that there are channels in common between the home region and the visited region the method proceeds in accordance with the “YES” branch to 319. In 319 a channel mapping is produced, which may be in the format of the channel mapping 273 shown in FIG. 2. Once the channel mapping is produced it may be stored in the visited television set. Alternatively, the channel mapping may be stored in the channel mapping storage unit which then remains connected to the television set for the duration of the traveling user's trip or for as long as the user want to have channel mapping capabilities. The method proceeds to 321 where the mapped channel numbers from the user's home region are displayed on the visited television set. Finally, the method proceeds to 323 and ends.

Various steps may be included or excluded as described above, or performed in a different order, with the remaining process still remaining within the scope of at least one exemplary embodiment. For example, in at least one exemplary embodiment, the step 317 of determining similar channels may be omitted. In other exemplary embodiments the step 317 may be performed regardless of whether any channels are found to be in common in block 315 (rather than performing 317 only via the “NO” branch from 315).

The processing units, processors and controllers described herein (e.g., processors 121 and 131 of FIGS. 1B and 1C respectively) may be of any type that can perform the stated functions. For example, a processor may be embodied as a Pentium, RISC processor, or any other type of processor that one of ordinary skill would recognize as being useful for the activities stated. A processing unit in accordance with at least one exemplary embodiment can operate computer software programs stored (embodied) on computer-readable medium (e.g. hard disk, CD, flash memory, ram, or other computer readable medium as recognized by one of ordinary skill). The computer software programs can aid or perform the steps described above. For example computer programs in accordance with at least one exemplary embodiment may include: a source code for identifying a region in an electronic desktop, where the region is a portion of the electronic desktop; a source code relating the electronic desktop to a first stored data region on a data storage medium; a source code for relating the identified region to a second data region on the data storage medium; a source code for sending the contents of the identified region to a remote display; a source code for reacting to a user interface to identify a region; a source code configured for allowing and aiding a user to identify a plurality of regions to select a region; and a source code for sending the contents of the identified region(s) to a processor, where the processor sends the contents of the electronic desktop to a video adapter. There are many further source codes that may be written to perform the stated steps and procedures above, and these are intended to lie within the scope of exemplary embodiments. Many various protocols may be used as part of exemplary embodiments (e.g. to transfer content). For example, presentation/ collaboration software (such as Sametime Connect and Netmeeting), remote desktop software (such as Microsoft RDC and VNC), and Xwindows for Unix/Linux, or other like programs or protocols known to those of ordinary skill in the art.

The use of the word “exemplary” in this disclosure is intended to mean that the embodiment or element so described serves as an example, instance, or illustration, and is not necessarily to be construed as preferred or advantageous over other embodiments or elements.

The description of the invention provided herein is merely exemplary in nature, and thus, variations that do not depart from the gist of the invention are intended to be within the scope of the embodiments of the present invention. Such variations are not to be regarded as a departure from the spirit and scope of the present invention.

What is claimed is:

1. A method of adapting an entertainment network setup for a first television to a second television in a visited location, the method comprising:
connecting, at the second television in a visited location, to a portable channel mapping storage unit;
receiving, at the second television, an input from the portable channel mapping storage unit, the input comprising information defining a first plurality of channels received by the first television, the information including a first plurality of channel numbers corresponding to the first plurality of channels;
mapping one or more of a second plurality of channels received at the second television to a corresponding one or more of the first plurality of channel numbers; and
displaying on the second television the one or more of the first plurality of channel numbers.

2. The method described in claim 1, wherein the first television is a home television located at a home location, the method further comprising:
detecting, at the first television, the first plurality of channels received at the home television.

3. The method described in claim 1, further comprising:
sensing, by the second television, the connecting of the portable channel mapping storage unit to the second television;
wherein the mapping of the one or more of the second plurality of channels is performed in response to the sensing.

4. The method described in claim 3, further comprising:
wherein the first plurality of channel numbers includes a first home channel number which identifies a first home channel received at the first television; and
wherein a first visited channel corresponds to the first home channel, the first visited channel being one of the second plurality of channels.

5. The method described in claim 4, further comprising:
receiving an input for a selection of the first home channel number on the second television; and
tuning the second television to the first visited channel in response to the selection of the first home channel number.

6. The method described in claim 4, wherein the receiving of the input further comprises:
receiving, at the second television, a signal from a television remote control to tune to the first home channel number.

7. The method described in claim 1, wherein the home television does not receive any of the second plurality of channels.

8. A computer readable media embodying a method of adapting an entertainment network setup for a first television to a second television in a visited location, the method comprising:
connecting, at the second television in a visited location, to a portable channel mapping storage unit;
receiving, at the second television, an input from the portable channel mapping storage unit, the input comprising information defining a first plurality of channels received by the first television, the information including a first plurality of channel numbers corresponding to the first plurality of channels;
mapping one or more of a second plurality of channels received at the second television to a corresponding one or more of the first plurality of channel numbers; and
displaying on the second television the one or more of the first plurality of channel numbers.

9. The computer readable media described in claim 8, wherein the first television is a home television located at a home location, the method further comprising:
detecting, at the first television, the first plurality of channels received at the home television.

10. The computer readable media described in claim 8, further comprising:
sensing, by the second television, the connecting of the portable channel mapping storage unit to the second television;
wherein the mapping of the one or more of the second plurality of channels is performed in response to the sensing.

11. The computer readable media described in claim 10, further comprising:
wherein the first plurality of channel numbers includes a first home channel number which identifies a first home channel received at the first television; and
wherein a first visited channel corresponds to the first home channel, the first visited channel being one of the second plurality of channels.

12. The computer readable media described in claim 1 1, further comprising:
receiving an input for a selection of the first home channel number on the second television; and
tuning the second television to the first visited channel in response to the selection of the first home channel number.

13. The computer readable media described in claim 1 1, wherein the receiving of the input further comprises:
receiving, at the second television, a signal from a television remote control to tune to the first home channel number.

14. The computer readable media described in claim 8, wherein the home television does not receive any of the second plurality of channels.

15. A visited television configured to adapt to an entertainment network setup for a home television, the method comprising:
an interface port disposed to receive a connector of a portable channel mapping storage unit;
a memory configured to store an input from the portable channel mapping storage unit, the input comprising information defining a first plurality of channels received by the home television, the information including a first plurality of channel numbers corresponding to the first plurality of channels;
a processor configured to map one or more of a second plurality of channels received at the visited television to a corresponding one or more of the first plurality of channel numbers; and
a channel display configured to display the one or more of the first plurality of channel numbers.

16. The visited television described in claim 15, further comprising:
wherein the interface port comprises means for sensing the connecting of the portable channel mapping storage unit to the second television; and
wherein the processor is configured to initiate the mapping of the one or more of the second plurality of channels in response to the sensing.

17. The visited television described in claim 15, further comprising:
wherein the first plurality of channel numbers includes a first home channel number which identifies a first home channel received at the home television; and
wherein a first visited channel corresponds to the first home channel, the first visited channel being one of the second plurality of channels.

18. The visited television described in claim 17, further comprising:
an infrared detector configured to receive an input for a selection of the first home channel number on the second television; and
a television tuner configured to tune the visited television to the first visited channel in response to the selection of the first home channel number.

19. The visited television described in claim 15, wherein the home television does not receive any of the second plurality of channels.
